(19) United States
(12) Patent Application Publication
(10) Pub. No.: US 2024/0190736 A1
(43) Pub. Date: Jun. 13, 2024

(54) AERATOR AND SYSTEM FOR REMOVAL OF VOLATILE ORGANIC COMPOUNDS

(71) Applicant: UGSI Solutions, Inc., Milpitas, CA (US)

(72) Inventors: Chris Levash, San Rafael, CA (US); Joshua Thaddeus Kurniawan, Milpitas, CA (US); Robin Giguere, Piedmont, CA (US); Billie Fritz, Fremont, CA (US)

(21) Appl. No.: 18/534,174

(22) Filed: Dec. 8, 2023

Related U.S. Application Data
(60) Provisional application No. 63/431,207, filed on Dec. 8, 2022.

(51) Int. Cl. C02F 1/74; B01F 23/213; C02F 1/00

(52) U.S. Cl. CPC C02F 1/74; B01F 23/2132; C02F 1/008; C02F 2101/30

(57) ABSTRACT

An aerator for use in removal of volatile organic compounds includes: a pipe float configured to float partially submerged on a water surface; a nozzle extending out of a top of the pipe float; a sleeve frame extending down from a bottom of the pipe float; a submersible motor and pump extending into the sleeve frame; and a bottom base attached to the sleeve frame. A system and method of removing volatile organic compounds is also included.

### CROSS-REFERENCE TO RELATED APPLICATIONS

This application claims priority to U.S. Provisional Application No. 63/431,207, filed on Dec. 8, 2022. The entire disclosure is incorporated herein by reference.

### BACKGROUND OF THE INVENTION

### Field of the Invention

The present invention is generally directed to an aerator and a system containing the same for removal of volatile organic compounds, and methods of removing volatile compounds using the aerator.

### Description of Related Art

Water delivered to humans, animals, and for agricultural uses is expected to be healthful. As such, it is desirable to remove contaminants such as volatile organic compounds (“VOCs”) from water systems prior to delivery to the consumers. Removal of such contaminants, especially trace amounts of such contaminants, can be problematic, however.

One method of removing VOCs is using an aerator to spray water into the air within a potable water storage tank, thereby liberating the VOCs from the water for subsequent removal from the storage tank. Although various aerators are known, these aerators have various drawbacks, such as requiring large tanks and reservoirs to operate properly and large tank openings to install and retrieve the aerators. Thus, it is desirable to provide an aerator that does not have such drawbacks.

### SUMMARY OF THE INVENTION

In certain non-limiting embodiments, provided is an aerator that helps to remove volatile organic compounds. The aerator comprises: a pipe float configured to float on a water surface; a nozzle extending out of a top of the pipe float; a sleeve frame extending down from a bottom of the pipe float; a submersible motor and pump extending into the sleeve frame; and a bottom base attached to the sleeve frame. In one non-limiting embodiments, the nozzle is configured to spray water from a body of water in a substantially horizontal and/or vertical direction with respect to the water surface.

In some non-limiting embodiments, the pipe float is made from high density polyethylene. The pipe float can also be filled with closed cell polyethylene foam material.

In certain non-limiting embodiments, a sleeve insert is positioned within the sleeve frame, and the submersible motor and pump extend into the sleeve insert. The aerator can also include additional components. For example, the aerator can also include U-bolts attached to the pipe float, and/or a submersible pump wire having splice connections. In addition, eyebolts can be attached to the submersible motor and pump.

In certain non-limiting embodiments, provided is a system for reducing an amount of volatile organic compounds. The system comprises: a reservoir comprising a body of water; and an aerator as previously described that is positioned in the body water in which the pipe float floats on the water surface of the body of water. It is appreciated that the pipe float is partially submerged in the body of water.

In some non-limiting embodiments, the reservoir comprises a vent where volatile organic compounds exit the reservoir. The system can further include a controller in operable communication with the aerator, and/or a mixing device submerged within the body of water, and/or an active ventilation device to move air exterior to the storage tank into the interior of the storage tank.

In certain non-limiting embodiments, provided is a method of removing volatile organic compounds from body of water. The method comprises: positioning an aerator as previously described in a body of water contained in a reservoir, in which the pipe float is partially submerged and floats on the water surface, and the submersible motor and submersible pump are submerged in the body of water; distributing water from the submersible pump toward the nozzle positioned above the water surface; and spraying water into air present in a headspace of the reservoir where the volatile organic compounds are liberated from the water for removal from the storage tank.

In one non-limiting embodiment, the water is sprayed substantially horizontally and/or vertically in the headspace with respect to the water surface. In some non-limiting embodiments, the volatile organic compounds exit the reservoir through a vent. The aerator can also be controlled during operation with a controller.

In certain non-limiting embodiments, the method further includes circulating water to the aerator with a mixing device submerged within the body of water.

The present disclosure is also directed to the following aspects.

Aspect 1: An aerator for use in removal of volatile organic compounds, the aerator comprising: a pipe float configured to float partially submerged on a water surface; a nozzle extending out of a top of the pipe float; a sleeve frame extending down from a bottom of the pipe float; a submersible motor and pump extending into the sleeve frame; and a bottom base attached to the sleeve frame.

Aspect 2: The aerator of aspect 1, wherein the pipe float is made from high density polyethylene.

Aspect 3: The aerator of aspects 1 or 2, wherein the pipe float is filled with closed cell polyethylene foam material.

Aspect 4: The aerator of any one of aspects 1-3, wherein the nozzle is configured to spray water from a body of water in a substantially horizontal and/or vertical direction with respect to the water surface.

Aspect 5: The aerator of any one of aspects 1-4, further comprising a sleeve insert positioned within the sleeve frame, wherein the submersible motor and pump extend into the sleeve insert.

Aspect 6: The aerator of any one of aspects 1-5, further comprising eyebolts attached to the submersible motor and pump.

Aspect 7: The aerator of any one of aspects 1-6, further comprising U-bolts attached to the pipe float.

Aspect 8: The aerator of any one of aspects 1-7, further comprising a submersible pump wire having splice connections.

Aspect 9: A system for reducing an amount of volatile organic compounds comprising: a reservoir comprising a body of water; and an aerator according to any one of aspects 1-8 positioned in the body of water, wherein the pipe float floats partially submerged on a water surface of the body of water.

Aspect 10: The system of aspect 9, wherein the reservoir comprises a vent where volatile organic compounds exit the reservoir.

Aspect 11: The system of aspect 9 or 10, further comprising a controller in operable communication with the aerator.

Aspect 12: The system of any one of aspects 9-11, further comprising a mixing device submerged within the body of water.

Aspect 13: The system of any one of aspects 9-12, wherein the reservoir comprises an active ventilation device to introduce external air into the tank.

Aspect 14: A method of removing volatile organic compounds from a body of water, the method comprising: positioning an aerator according to any one of aspects 1-8 in a body of water contained in a reservoir, wherein the pipe float floats partially submerged on a water surface and the submersible motor and submersible pump are submerged in the body of water; distributing water from the submersible pump toward the nozzle positioned above the water surface; and spraying water into air present in a headspace of the reservoir where the volatile organic compounds are liberated from the water for removal.

Aspect 15: The method of aspect 14, wherein the water is sprayed substantially horizontally and/or vertically in the headspace with respect to the water surface.

Aspect 16: The method of aspect 14 or 15, wherein the volatile organic compounds exit the reservoir through a vent.

Aspect 17: The method of any one of aspects 14-16, wherein the aerator is controlled during operation with a controller.

Aspect 18: The method of any one of aspects 14-17, further comprising introducing external air into the tank with an active ventilation device.

Aspect 19: The method of any one of aspects 14-18, further comprising circulating water to the aerator with a mixing device submerged within the body of water.

### BRIEF DESCRIPTION OF THE DRAWINGS

FIG. 1 is a perspective view of an aerator of the present disclosure;

FIG. 2 is a top view of an aerator of the present disclosure;

FIG. 3 is a side view of an aerator of the present disclosure;

FIG. 4 is an expanded view of a U-bolt on an aerator of the present disclosure with a cable extending through the bolt;

FIG. 5 is a side view of a pump and motor assembly that forms a portion of the aerator;

FIG. 6 is a perspective view of an aerator of the present disclosure with cables extending through U-bolts and a submersible pump wire; and

FIG. 7 is a water treatment system having an aerator according to the present disclosure.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiments of the invention. Hence, specific dimensions and other physical characteristics related to the embodiments disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

It will also be appreciated that the dimensions and sizes provided in the drawings are only non-limiting examples. Therefore, different dimensions and sizes can be used.

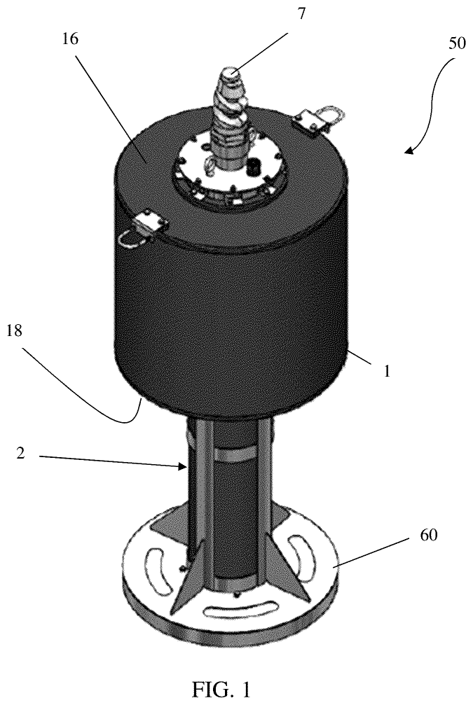

Referring to FIG. 1, and in one preferred and non-limiting embodiment, the present disclosure is directed to an aerator 50 for use in removing volatile organic compounds (VOCs). As shown in FIG. 1, the aerator 50 includes a pipe float 1, a nozzle 7 extending out of the top 16 of the pipe float 1, a sleeve frame 2 that extends down from the bottom 18 of the pipe float 1, and bottom base 60 attached to the sleeve frame 2. As shown in FIG. 1, the pipe float 1 can be larger than the sleeve frame 2. For instance, in certain non-limiting embodiments, the pipe float 1 can have a larger circumference than the sleeve frame 2 such that the pipe float 1 extends out a greater distance than the sleeve frame 2.

It will be appreciated that the pipe float 1 provides sufficient buoyancy to allow the aerator 50 to float partially submerged on the surface of a body of water. To allow for such buoyancy, the pipe float 1 can be made of certain materials and/or filled with certain materials to allow the aerator 50 to float partially submerged on the surface of a body of water. In certain non-limiting embodiments, the pipe float 1 is made from high density polyethylene (HDPE). As indicated, the pipe float 1 can also be filled with materials that allows the aerator 50 to float. For example, the pipe float 1 can be filled with closed cell polyethylene foam material.

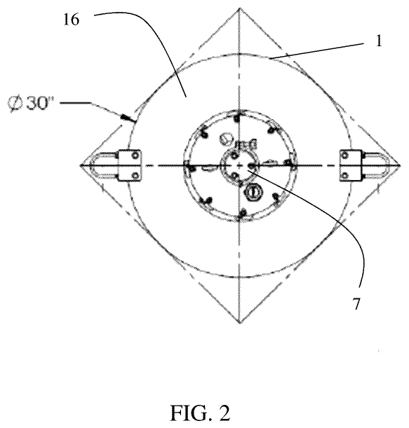

Referring to FIGS. 1-3, the spray nozzle 7 extends out of the top 16 of the pipe float 1 and is configured to spray water from a body of water into the air where the VOCs are removed. As shown in FIG. 2, the nozzle 7 can be positioned in a center portion of the top 16 of the pipe float 1. It will be appreciated that the angle (30″) shown in FIG. 2 is a non-limiting example of an angle at which the top 16 of the pipe float 1 can be formed.

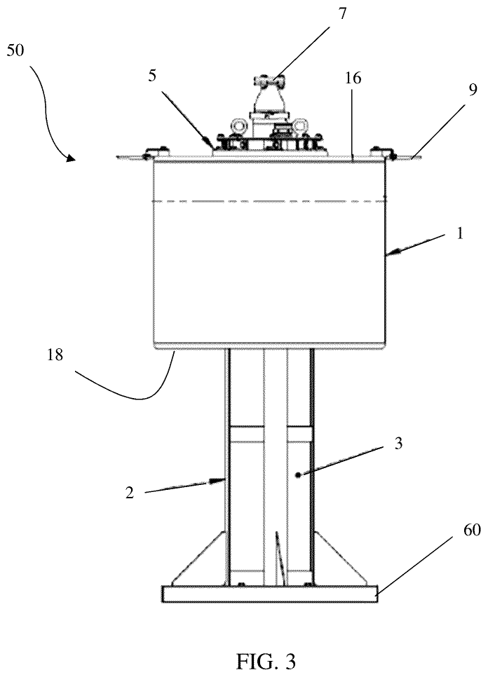

As shown in FIG. 3, the nozzle 7 can be secured to the pipe float 1 with various fastening devices such as a pump flange joining bracket 5. The nozzle 7 used with the aerator 50 can spray water in various directions. For instance, the nozzle 7 can be used to spray water in the substantially horizontal and/or vertical direction, such as the vertical and/or horizontal direction. It was found that spraying water in the horizontal directions requires less head space in a water reservoir for removing VOCs.

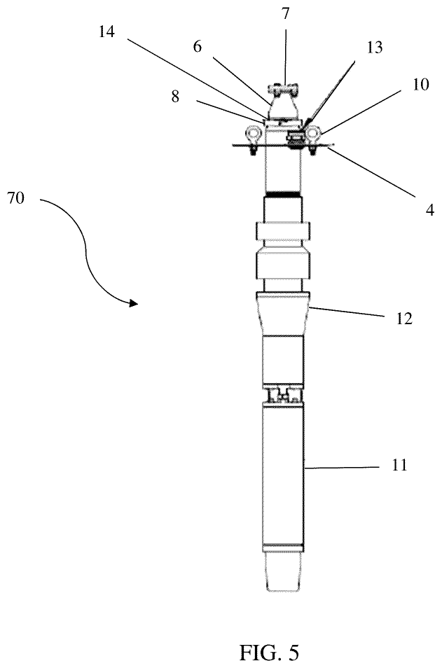

As shown in FIG. 5, the nozzle 7 is part of a pump and motor assembly 70. The pump and motor assembly 70 includes the nozzle 7, a submersible motor 11, and a submersible pump 12. The pump and motor assembly 70 can also include other components. For example, in certain non-limiting embodiments, the pump and motor assembly 70 further includes a nozzle flange weldment 6, clamps 8, gaskets 14, a pump header bracket 4, and an electrical cable strain relief 13 that all can be used to secure an electrical motor cable to the assembly 70 with the pipe float 1. The pump and motor assembly 70 can further include eyebolts 10 for lifting the assembly 70, or the entire aerator 50, or for attaching to cables that hold the aerator 50 in position within a reservoir.

In certain non-limiting embodiments, the pump and motor assembly 70 can be shaped and sized to be placed into the pipe float 1 and sleeve frame 2 with the nozzle 7 extending out of the top 16 of the pipe float 1. For example, referring to FIGS. 1 and 3, the pump and motor assembly 70 can be inserted into a sleeve insert 3 formed into the sleeve frame 2. The sleeve insert 3 and frame 2 allow the pump and motor assembly 70 to be inserted and removed from the aerator 50 to repair, modify, replace or clean the pump and motor assembly 70.

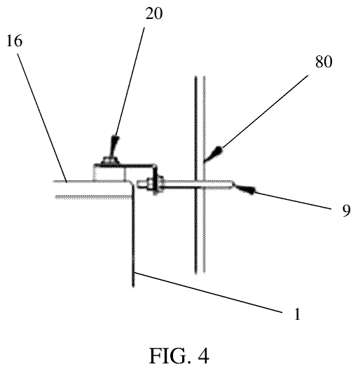

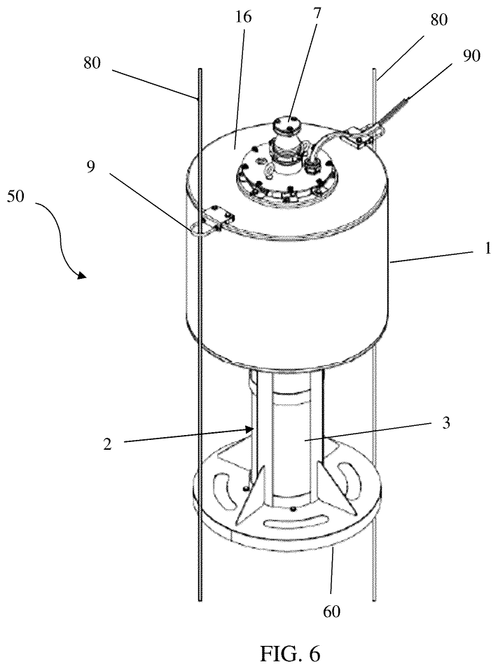

Referring to FIGS. 4 and 6, the aerator 50 can also have U-bolts 9. The U-bolts 9 can be attached to the pipe float 1, such as with a bracket 20 bolted to the top 16 of the pipe float 1. The U-bolts 9 can be used to move the aerator 50 or to hold it in place. For example, cables 80 can extend through the U-bolts 9 and used to move the aerator 50 or to hold it in place.

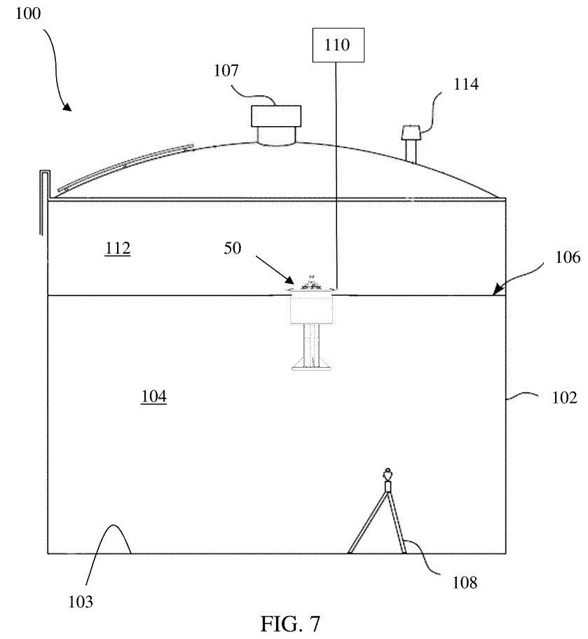

In certain non-limiting embodiments, the aerator 50 can be operated with a controller 110 as shown in FIG. 7. For instance, referring to FIG. 6, the aerator 50 may further include a submersible pump wire having splice connections 90 that extends to a controller 110, such as a control panel. The controller 110 can be used to automatically operate the aerator 50.

It is appreciated that controller 110 may include one or more microprocessors, CPUs, and/or other computing devices. One or more computer-readable storage mediums can be in operable communication with the controller 110. The computer-readable storage mediums can contain programming instructions that, when executed, cause the controller 110 to perform multiple tasks. This includes programming algorithms that allow the controller 110 to control the aerator 50 and when water is sprayed to remove VOC's from a reservoir during desired conditions or time periods. The programming instructions can be updated and modified.

The previously described aerator 50 can also be sized and shaped to fit in various types of reservoirs and tanks. For example, in one non-limiting embodiment, the aerator weights between 200 and 600 pounds, such as between 400 and 500 pounds. In such non-limiting embodiments, the aerator 50 can also have a diameter between 20″ and 40″, such as about 30″, with respect to the pipe float 1, and/or have a height between 5 and 8 feet, such as between 6 and 7 feet. The aerator can also provide a desired splash diameter and splash height. For examples, the aerator can provide a desired splash diameter of up to 30 feet or about 30 feet, and/or a splash height of up to 7 feet or about 7 feet.

As shown in FIG. 7, the present disclosure is also directed to a system 100 for removing VOCs from a body of water 104. The system 100 includes a reservoir 102 containing a body of water 104 with one or more of any of the previously described aerators 50 floating on the water surface 106 and which is partially submerged in the body of water 104 as previously described. The system 100 can also include a vent 107 and/or a mixing device 108. Non-limiting embodiments of mixing devices 108 includes a mixer having blades, such as an impeller for example, that can be submerged in the body of water 104 (e.g., completely submerged in the body of water 104) and/or an active ventilation device 114 that conveys air external to the reservoir 102 into the interior of the reservoir 102.

As previously noted, the system 100 can further include a mixing device 108. The mixing device 108 can be substantially immersed below the water surface 106. The mixing device 108 can also be configurable to substantially not generate formation of bubbles at the water surface 106. In certain non-limiting embodiments, the mixing device 108 facilitates the movement of the body of water 104 within the reservoir 102. In some non-limiting embodiments, the mixing device 108 can be configured to exchange water at or toward the floor 103 of the reservoir 102 with water at or toward the water surface 106.

The mixing device 108 can also continuously or substantially continuously convey stored water 104 from below the water surface 106 to the water surface 106 (that is, the air/water interface). In certain non-limiting embodiments, water is circulated around the reservoir 102 in a top to bottom configuration. It will be appreciated that the mixing device 108 circulates water to the aerator 50 in order to remove VOC's from different areas of reservoir 102.

As further shown in FIG. 7, the system 100 can further include a controller 110 as previously described, such as a control panel that is in operable communication with the aerator 50. In some non-limiting embodiments, the controller 110 is in operable communication with a submersible pump wire having splice connections 90 located on the aerator 50.

To adjust and/or hold the aerator 50 in place, the system 100 can further include any of the previously described cables 80. That is, the system 100 can use the cables 80 to extend through the U-bolts 9 in order to move the aerator 50 or to hold it in place.

The present disclosure is also directed to a method of removing VOCs using the previously described system 100 and aerator 50. For instance, during operation of the system 100, the aerator 50 is positioned on the body of water 104 contained in the reservoir 102 such that the pipe float 1 of the aerator 50 floats partially submerged on the water surface 106 with the submersible motor 11 and submersible pump 12 submerged in the body of water 104. The submersible motor 11 and submersible pump 12 distribute water up toward the nozzle 7 positioned above the water surface 106. The water is then sprayed, such as horizontally and/or vertically, into the air of the headspace 112 of the reservoir 102 where the VOCs are liberated from the water for removal. The VOCs can then exit the reservoir 102 through a vent 107. The aerator 50 can also be controlled during operation with a controller 110 as previously described.

To remove VOC's in the water located in different areas of the reservoir 102, the previously described mixing device 108 can be placed in the body of water 104. For instance, the mixing device 108 can be submerged within the body of water 104 and circulate water to the aerator 50 in order to remove VOC's from different areas of reservoir 102.

It was found that the previously described aerator 50, system 100, and method removes VOCs from water and helps to overcome large headspace requirements, reduce issues with mooring requirements (e.g., avoiding welding requirements), and allow for easy installation and servicing (e.g., easy removal of the motor and pump assembly for servicing or replacement).

Whereas particular embodiments or aspects of this invention have been described above for purposes of illustration, it will be evident to those skilled in the art that numerous variations of the details of the present invention may be made without departing from the invention as defined in the appended claims.

The invention claimed is:

1. An aerator for use in removal of volatile organic compounds, the aerator comprising:
a pipe float configured to float partially submerged on a water surface;
a nozzle extending out of a top of the pipe float;
a sleeve frame extending down from a bottom of the pipe float;
a submersible motor and pump extending into the sleeve frame; and
a bottom base attached to the sleeve frame.

2. The aerator of claim 1, wherein the pipe float is made from high density polyethylene.

3. The aerator of claim 1, wherein the pipe float is filled with closed cell polyethylene foam material.

4. The aerator of claim 1, wherein the nozzle is configured to spray water from a body of water in a substantially horizontal and/or vertical direction with respect to the water surface.

5. The aerator of claim 1, further comprising a sleeve insert positioned within the sleeve frame, wherein the submersible motor and pump extend into the sleeve insert.

6. The aerator of claim 1, further comprising eyebolts attached to the submersible motor and pump.

7. The aerator of claim 1, further comprising U-bolts attached to the pipe float.

8. The aerator of claim 1, further comprising a submersible pump wire having splice connections.

9. A system for reducing an amount of volatile organic compounds comprising:
a reservoir comprising a body of water; and
an aerator according to claim 1 positioned in the body of water, wherein the pipe float floats partially submerged on a water surface of the body of water.

10. The system of claim 9, wherein the reservoir comprises a vent where volatile organic compounds exit the reservoir.

11. The system of claim 9, further comprising a controller in operable communication with the aerator.

12. The system of claim 9, further comprising a mixing device submerged within the body of water.

13. The system of claim 9, wherein the reservoir comprises an active ventilation device to introduce external air into the tank.

14. A method of removing volatile organic compounds from a body of water, the method comprising:
positioning an aerator according to claim 1 in a body of water contained in a reservoir, wherein the pipe float floats partially submerged on a water surface and the submersible motor and submersible pump are submerged in the body of water;
distributing water from the submersible pump toward the nozzle positioned above the water surface; and
spraying water into air present in a headspace of the reservoir where the volatile organic compounds are liberated from the water for removal.

15. The method of claim 14, wherein the water is sprayed substantially horizontally and/or vertically in the headspace with respect to the water surface.

16. The method of claim 14, wherein the volatile organic compounds exit the reservoir through a vent.

17. The method of claim 14, wherein the aerator is controlled during operation with a controller.

18. The method of claim 14, further comprising introducing external air into the tank with an active ventilation device.

19. The method of claim 14, further comprising circulating water to the aerator with a mixing device submerged within the body of water.
